(19) United States
(12) Patent Application Publication
(10) Pub. No.: US 2005/0071823 A1
(43) Pub. Date: Mar. 31, 2005

(54) Apparatus and method for simulating segmented addressing on a flat memory model architecture

(76) Inventors: Xiaodong Lin, Shanghai (CN); Yun Wang, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/673,699

(22) Filed: Sep. 29, 2003

(51) Int. Cl. G06F 9/45

(52) U.S. Cl. 717/136

(57) ABSTRACT

In some embodiments, a method and apparatus for simulating segmented addressing on a flat memory model architecture are described. In one embodiment, the method includes the translation of instructions from a source instruction set architecture (ISA) having a segmented memory addressing model into a target ISA having a non-segmented memory addressing model. The conversion of instructions into translated instructions for execution within the target ISA is performed by simulating a segmented memory addressing model within the target ISA for the translated instructions. In one embodiment, hardware components and data structures of the target ISA are allocated to simulate the segmented memory addressing model within the target ISA. Accordingly, translated code utilizes allocated flags, such as predicate registers, in order to convert translated program statements having logical address expressions into linear addressing expressions supported by the target ISA. Other embodiments are described and claimed.

### FIELD OF THE INVENTION

One or more embodiments of the invention relate generally to the field of segmented addressing model architectures. More particularly, one or more of the embodiments of the invention relate to a method and apparatus for simulating segmented addressing on a flat address model architecture.

### BACKGROUND OF THE INVENTION

Generally, computer programs are initially written in high level program statements. In order to be executed by a computer, the program statements are compiled into machine instructions that a microprocessor can recognize and execute. The machine instructions are selected from a set of machine instructions unique to a particular instruction set architecture (ISA).

Computer program statements that have been decoded into machine instructions for a source ISA such as Intel® X86, may undergo a binary translation in order to be executed at a target ISA, such as a reduced instruction set computing (RISC) architecture, or a very long instruction word (VLIW) architecture.

The translation may be performed by a dynamic translator, typically stored in memory. During translation, instructions are typically translated one basic block of instructions (BB) at a time and stored in memory. For example, each basic block of instructions may include a contiguous sequence of non-branch instructions (i.e., do not change order of executing instructions) which typically ends with a conditional branch instruction.

Unfortunately, some architectures support a segmented addressing model for protection or historical reasons. In a segmented addressing model, the processor represents a logical address with a segment selector. A segment selector includes two sections: a segment identifier and an offset, such as, for example, ds:[0x400000]. This example represents a segmented address used by architectures which support a segmented addressing model in which ds denotes a segment register holding the segment selector and 0x400000 represents an offset. To translate a logical address, such as provided above, into a linear address, segmentation hardware locates the base linear address of a segment by looking up a segment table indexed by the segment selector and then adding the base linear address to the offset.

Unfortunately, running such code with a dynamic binary translator on a flat addressing model architecture is not possible since the architecture does not support the segmented memory model. Accordingly, certain programs that are written according to a segmented addressing model may generally not be translated for execution within an architecture that is limited to a flat memory addressing mode. Therefore, there remains a need to overcome one or more of the limitations in the above-described, existing art.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system including a translator to enable simulation of a segmented addressing model on a flat memory model architecture, in accordance with one embodiment of the invention.

FIG. 2 is a block diagram illustrating a segmented memory addressing model, as known to those skilled in the art.

FIG. 3 is a block diagram further illustrating the translator of FIG. 1, in accordance with one embodiment of the invention.

FIG. 4 is a block diagram illustrating run-time linear address calculation within a target instruction set architecture (ISA), which simulates a segmented memory addressing model for translated source ISA applications, in accordance with one embodiment of the invention.

FIG. 5 is a flowchart illustrating a method for simulating a segmented memory addressing model within a target ISA having a flat memory addressing model, in accordance with one embodiment of the invention.

FIG. 6 is a flowchart illustrating a method for allocating target ISA resources in order to enable simulation of a segmented memory addressing model within a flat memory model architecture, in accordance with one embodiment of the invention.

FIG. 7 is a flowchart illustrating a method for translating instructions from the source ISA into a target ISA to simulate a segmented memory addressing model, in accordance with one embodiment of the invention.

FIG. 8 is a flowchart illustrating a method for translating source ISA instructions into target ISA instructions to simulate a segmented memory addressing model within the target ISA, in accordance with one embodiment of the invention.

FIG. 9 is a flowchart illustrating a method for simulating a segmented memory addressing model within a flat memory model, target ISA, in accordance with one embodiment of the invention.

FIG. 10 is a flowchart illustrating a method for performing run time linear address calculation within a flat memory model architecture, implementing segmented model addressing, in accordance with one embodiment of the invention.

### DETAILED DESCRIPTION

A method and apparatus for simulating segmented addressing on a flat memory model architecture are described. In one embodiment, the method includes the translation of instructions from a source instruction set architecture (ISA) having a segmented memory addressing model into a target ISA having a non-segmented memory addressing model. The conversion of instructions into translated instructions for execution within the target ISA is performed by simulating a segmented memory addressing model within the target ISA for the translated instructions. In one embodiment, hardware components and data structures of the target ISA are allocated to simulate the segmented memory addressing model within the target ISA. Accordingly, translated code utilizes allocated flags, such as predicate registers, in order to convert translated program statements having logical address expressions into linear addressing expressions supported by the target ISA.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logical. The integrated circuit may take the form of a processor such as a microprocessor, application specific integrated circuit, a digital signal processor, a micro-controller, or the like.

An example of “software” includes executable code in the form of an application, an applet, a routine or even a series of instructions. The software may be stored in any type of computer or machine readable medium such as a programmable electronic circuit, a semiconductor memory device inclusive of volatile memory (e.g., random access memory, etc.) and/or non-volatile memory (e.g., any type of read-only memory “ROM,” flash memory), a floppy diskette, an optical disk (e.g., compact disk or digital versatile disk “DVD”), a hard drive disk, tape, or the like.

In one embodiment, the present invention may be provided as an article of manufacture which may include a machine or computer-readable medium having stored thereon instructions which may be used to program a computer (or other electronic devices) to perform a process according to one embodiment of the present invention. The computer-readable medium may include, but is not limited to, floppy diskettes, optical disks, Compact Disc Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

System Architecture

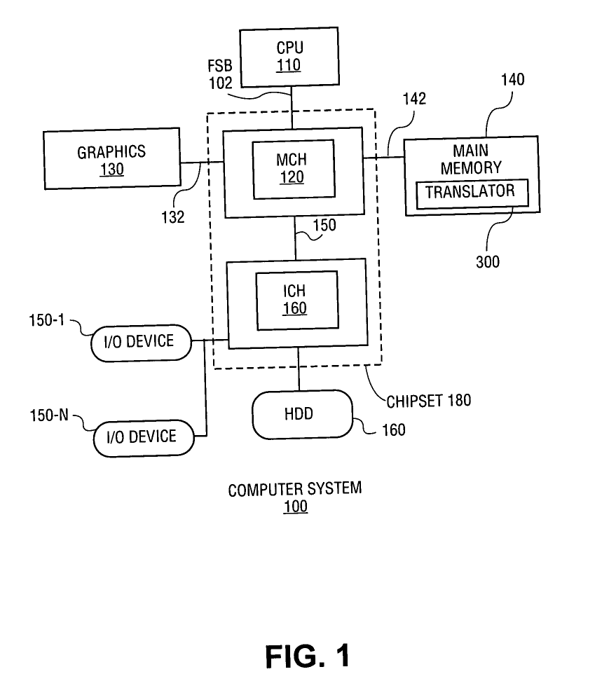

FIG. 1 is a block diagram illustrating a computer system 100 including a dynamic binary translator 300, in accordance with one embodiment of the invention. As illustrated, computer system 100 includes a processor (CPU) 110, memory 140 and an optional graphics controller 130 coupled to memory controller hub (MCH) 120. As described herein, MCH 120 may be referred to as a north bridge and, in one embodiment, as a memory controller. In an alternate embodiment, MCH 120 may be implemented within CPU 110. In addition, computer system 100 includes I/O (input/output) controller hub (ICH) 160. As described herein ICH 160 may be referred to as a south bridge or I/O controller. South bridge, or ICH 160, is coupled to I/O devices 150 (150-1, . . . , 150-N) and hard disk drive devices (HDD) 160.

In one embodiment, memory 140 is volatile memory, including but not limited to, random access memory (RAM), synchronous RAM (SRAM), synchronous dynamic RAM (SDRAM), double data rate (DDR) SDRAM (DDR-SDRAM), Rambus dynamic RAM (RDRAM) or the like. Collectively, MCH 120 and ICH 160 are referred to as chipset 180. As is described herein, the term “chipset” is used in a manner well known to those skilled in the art to describe, collectively, the various devices coupled to CPU 110 to perform desired system functionality. In one embodiment, functionality of one or both MCH 120 and ICH 160 may be implemented within CPU 110.

In contrast to conventional computer systems, computer system 100 includes dynamic binary translator 300 for translating binary applications written for a source instruction set architecture (ISA) into a target instruction set architecture (ISA) of computer system 100. In one embodiment, computer system 100 may be referred to as a very long instruction word (VLIW) architecture. In one embodiment, computer system 100 is configured as an explicitly parallel instruction computing (EPIC) architecture. As described herein, VLIW architectures, EPIC architectures, and the like are collectively referred to herein as a target ISA. In contrast, as described herein, the term “source ISA” may refer to ISAs having instruction words that are smaller that the VLIW architecture capabilities of computer system 100.

In one embodiment, computer system 100 may refer to a computer architecture manufactured by the Intel® Corporation of Santa Clara, Calif., to process, for example, 64-bit, 128-bit, or larger instruction words. In contrast, source ISAs may refer to computer architectures configured to handle 32-bit instruction words. Accordingly, in the embodiments described in further detail below, VLIW instruction set architectures, such as computer system 100, are required to provide compatibility with legacy or source ISAs by translating binary applications of the source ISAs according to a target ISA of computer system 100. In one embodiment, the translation is performed using dynamic binary translator 300.

The source ISA may operate according to a segmented memory addressing model. A segmented memory addressing model divides a processor's addressable memory space (linear address space) into protected address spaces, generally referred to as segments. As a result, memory appears as a group of independent address spaces, or segments, to the devices which access memory. As such, segmentation provides a mechanism for isolating individual code, data and stacks into separate memory segments so that multiple programs or stacks can run on the same processor without interfering with one another.

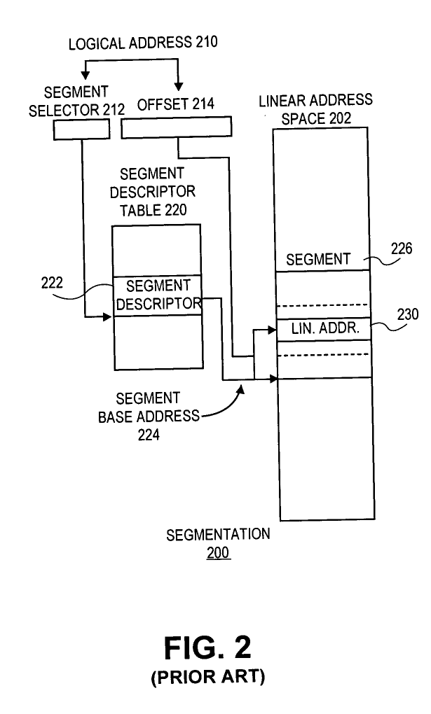

FIG. 2 depicts a block diagram illustrating segmentation 200 as performed within a source ISA. As illustrated, linear address space 202 is divided into various segments. To locate a byte in a particular segment, a program or application issues a logical address 210. As illustrated, the logical address is comprised of a segment selector 212 and an offset 214. The segment selector 212 is a unique identifier for the segment by providing an offset into segment descriptor table 220. As illustrated, each segment includes a segment descriptor which specifies the size of the segment, the access rights and privilege levels for the segment, the segment type and the location of the first byte of the segment in the linear address space, which is referred to herein as the base address of the segment.

Accordingly, in response to logical address 210, source ISA utilizes segment selector 212 to identify a segment descriptor 222 within segment table 220. Segment descriptor 222 describes a segment to be accessed by the application or program which issued logical address 210. In response, the source ISA identifies segment base address 224 according to segment descriptor 222. Using base address 224, the base address 224 may be combined with offset 214 to convert logical address 210 into linear address 230. As illustrated, segment base address 224 identifies the start position, or address, of segment 226 within linear address space 202. Likewise, offset 214 provides a location of the desired byte within the segment or linear address space 230.

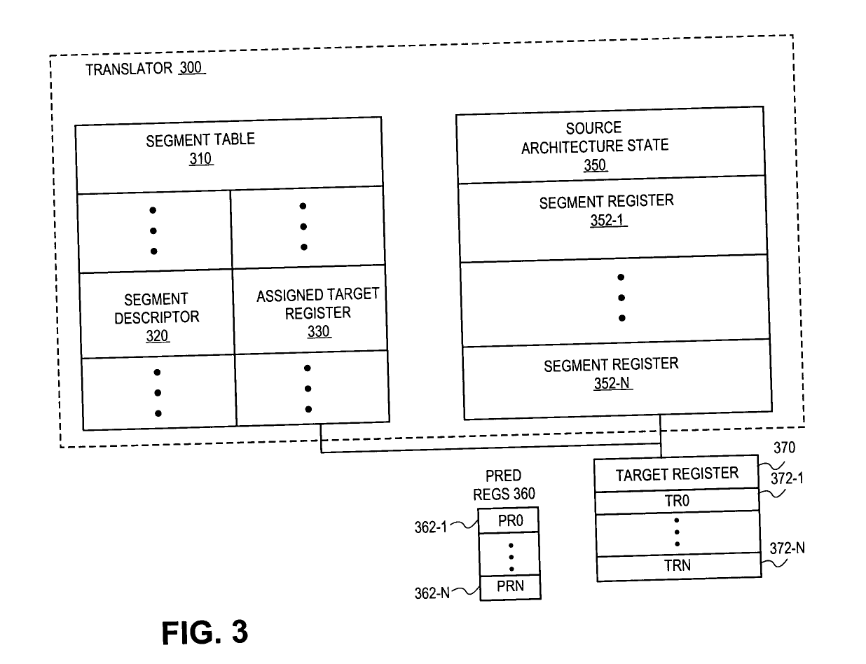

Unfortunately, as indicated above, computer system 100, which is referred to herein as target ISA 100 may not support segmentation 200, as illustrated with reference to FIG. 3. As indicated above, target ISA 100 includes translator 300 for translating binary applications of source ISA according to the target ISA of computer system 100. During translation, instructions are typically translated one block of instructions (BB) at a time and stored in memory in an area allocated for storing translated BBs. As such, the machine instructions of a source program are typically translated and stored in memory in separate blocks of instructions. In one embodiment, each block of instructions consists of a continuous sequence of non-branch machine instructions ending with the branch instruction.

Accordingly, a binary application such as the untranslated source binary application is typically comprised of multiple blocks of instructions stored in the physical static sequence. In order to execute translated source applications which function according to a segmented addressing model, translator 300 is configured as illustrated with reference to FIG. 3. In the embodiments illustrated, translator 300 is implemented in software. In an alternative embodiment, translator 300 may be implemented in hardware, such as within processor 110, chipset 180, or the like.

As illustrated with reference to FIG. 3, translator 300 allocates and maintains a segment table 310 within the target ISA, which is analogous to segment descriptor table 220. However, in contrast to segment descriptor table 220 (FIG. 2), the segment table 310 allocated by translator 300 stores not only a segment descriptor 320, but also an assigned target register 330. Accordingly, in the embodiment illustrated, when translator 300 encounters a source application segment table update (system call/source ISA instruction), the segment descriptor 320 associated with the detected segment table update is stored within segment table 310. In addition, at such time, in one embodiment, translator 310 assigns a target register from target registers 370.

In one embodiment, the target registers may include general purpose registers provided by the target ISA 100, which may be stored within chipset 180 or processor 110. Accordingly, in the embodiment illustrated, the segment descriptor or segment described by the segment descriptor, is assigned a target register, which is stored within column 330 of segment table 310. In order to further implement a segmented addressing model, translator 300 maintains source architecture state table 350. However, in contrast to conventional segmentation, target ISA does not provide segment register used by source ISA. Generally, conventional segmentation requires storage of a segment descriptor within a segment register before the segment may be accessed by an application or program.

As illustrated, state table 350 includes various entries for segment registers 350 (352-1, . . . , 352-N). As such, translator 300 maintains a source ISA state instead of allocating segment registers as utilized within conventional segmented addressing models. Unfortunately, the number of allocated segment registers within a source ISA is generally limited to, for example, six segment registers for holding up to six segment selectors. For example, the segment registers may support a specific kind of memory reference, such as code, stack or data.

Accordingly, in the embodiment illustrated, translator 300 allocates an entry within source architecture state table 350 to provide a corresponding entry with respect to each segment register utilized by the source ISA. In one embodiment, when translator 300 detects a segment register update instruction within a source application, translator 300 will identify the corresponding segment descriptor within segment table 310 to identify the assigned target register 330. Once assigned, translator 300 may update a predicate register 362 (362-1, . . . , 362-N) to identify the target register assigned to the segment. Furthermore, at such time, the assigned target register may be populated with a base address of the segment.

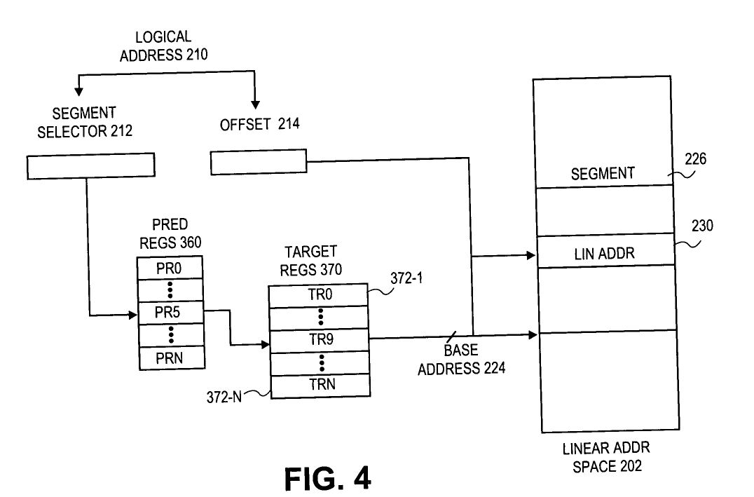

In an alternative embodiment, the base address is stored within target register at the time the target register is assigned to the segments described by the segment descriptor 320. In the embodiment illustrated, target ISA uses predicate registers 360, which provide a means for implementing conditional state information within target ISA. However, such state information may be maintained within an allocated data structure provided by the various target ISAs for implementing embodiments of the invention. Accordingly, once translation of a source ISA application is complete, in one embodiment, translator 300 may simulate segmented memory addressing within the target ISA, as illustrated with reference to FIG. 4.

As illustrated in FIG. 4, upon detection of a logical address 210 within the translated source ISA application, segment selector 214 is compared with predicate registers 360 to identify a target register containing a base address of the segment associated with logical address 210. In the embodiment illustrated, segment selector 214 may provide, for example, a segment register of source ISA. Once determined, the predicate register 362, containing information regarding the segment register, is identified, such as, for example, predicate register 5 (PR5), 362-6. In the embodiment illustrated, PR5 362-6 identifies target register 9 (TR9) 372-10, as containing base address 224 of the segment. Accordingly, base address 224 is added with offset 214 to compute the linear address 230 corresponding to logical address 210. Procedural methods for implementing further embodiments of the invention are now described.

Operation

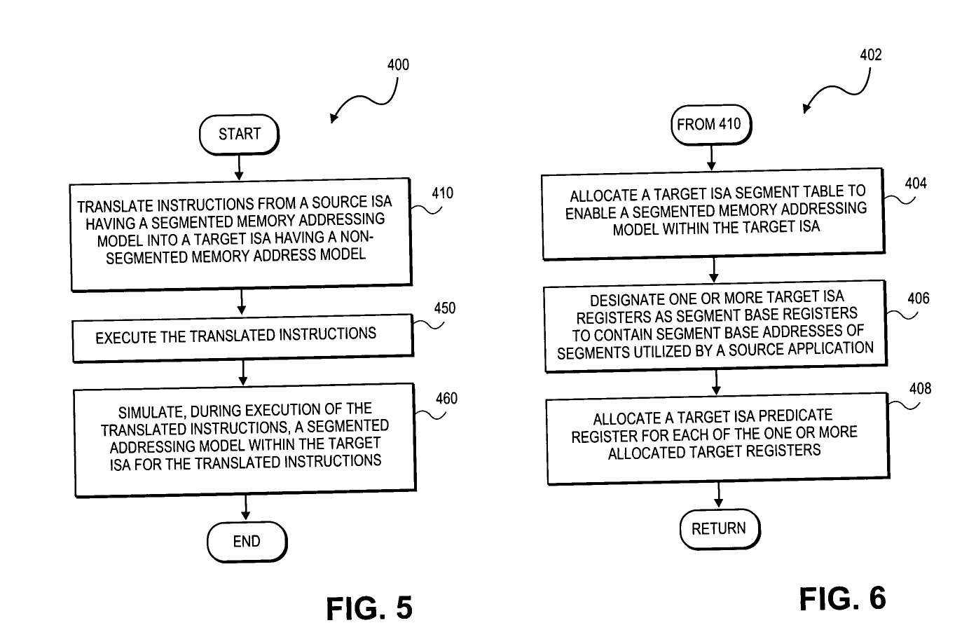

FIG. 5 is a flowchart illustrating method 400 for simulating a segmented addressing model on a flat memory model architecture, in accordance with one embodiment of the invention, as further illustrated with reference to FIGS. 3 and 4. At process block 410, instructions from a source instruction set architecture (ISA) having a segmented memory addressing model are translated into a target ISA having a non-segmented memory addressing model. A target ISA having a non-segmented memory address and model is illustrated with reference to FIG. 1. In accordance with one embodiment, translator 300 is responsible for simulating a segmented memory addressing model within target ISA 100 to enable execution of translated source ISA applications written according to a segmented memory addressing model.

Once translation of a source ISA application is complete, the source ISA application is executed at process block 450. During execution of the translated instructions, at process block 460 the segmented memory addressing model is simulated within the target ISA for the translated instructions. As illustrated with reference to FIG. 3, simulation of segmented addressing is performed by implementing a segmentation table within the target ISA as well as assigning target ISA registers to store a base address of each segment utilized by a current application thread. In a further embodiment, predicate registers corresponding to assigned target registers identify a mapping between source ISA segment registers and assigned target registers.

FIG. 6 is a flowchart illustrating a method 402 for allocating target ISA resources to enable simulation of segmented memory addressing within target ISA in accordance with one embodiment of the invention. At process block 404, a target ISA segment table is allocated to enable segmented memory addressing within the target ISA. At process block 406, one or more target registers are designated as segment base registers to contain segment base addresses of segments utilized by a source application or thread. At process block 408, a target ISA predicate register is allocated for each of the one or more allocated target registers. In an alternate embodiment, a mapping between the designated target ISA registers and segment registers of the source ISA may be performed by allocating a target ISA memory structure or data structure to maintain such mapping.

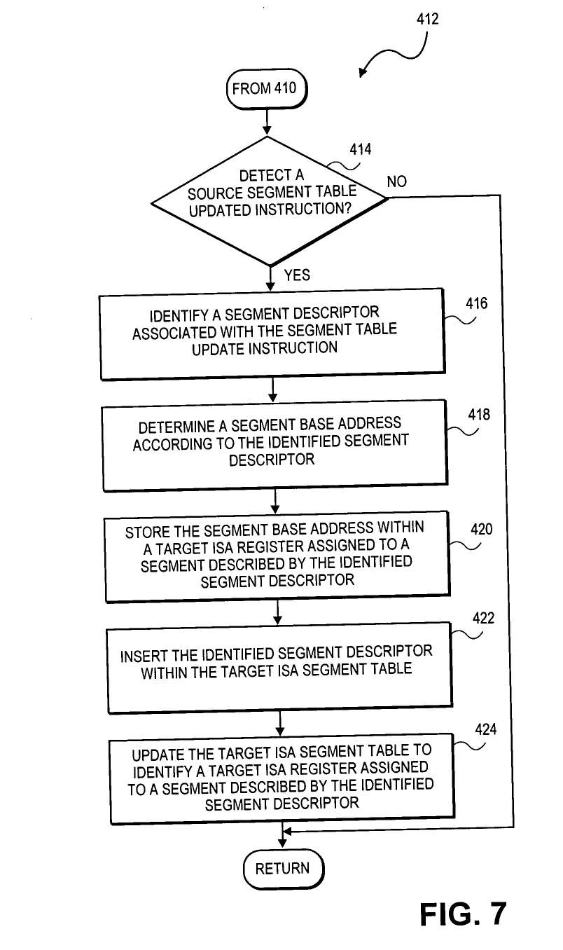

FIG. 7 is a flowchart illustrating a method 412 for translating instructions of process block 410 of FIG. 5 in accordance with one embodiment of the invention. At process block 414, it is determined whether a source segment table update is detected. In one embodiment, a segment table update is detected in response to identification of a segment table update instruction within, for example, a source ISA application. In an alternate embodiment, a segment table update is detected in response to identification of a system or operating system (OS) call to update the source ISA segment table. When a segment table update instruction is detected, process block 416 is performed.

At process block 416, a segment descriptor associated with the segment table update instruction is identified. Once the segment descriptor is identified, at process block 418, a segment based address of a segment described by the segment descriptor is determined according to the identified segment descriptor. At process block 420, the segment base address is stored within a target ISA register assigned to the segment described by the identified segment descriptor, for example, as depicted with reference to FIG. 3. At process block 422, the identified segment descriptor is inserted into the segment table maintained by the target ISA. At process block 424, the target ISA segment table is updated to identify a target ISA register assigned to a segment described by the identified segment descriptor.

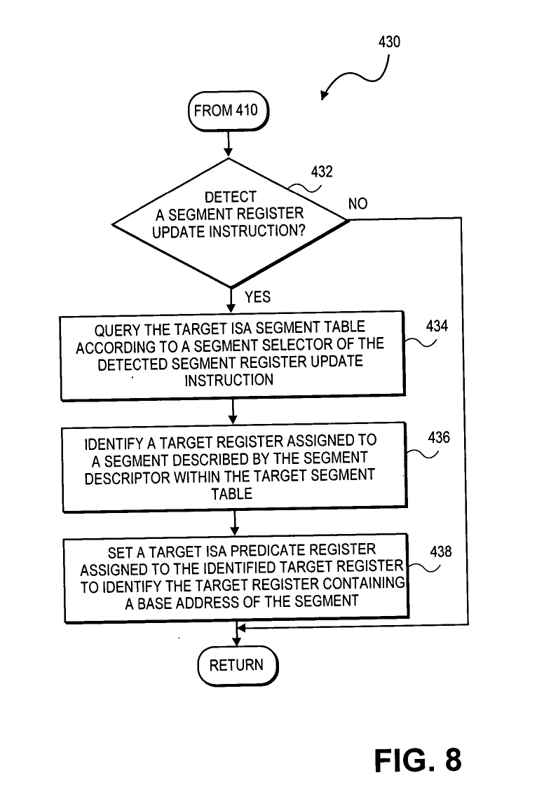

FIG. 8 is a flowchart illustrating a method 430 for translating instructions of process block 410 of FIG. 5, in accordance with one embodiment of the invention. At process block 432, it is determined whether a segment register update instruction is detected within a source ISA application. When such instruction is detected, process block 436 is performed. At process block 434, a target ISA segment table is queried according to a segment selector of the detected segment register update instruction. At process block 436, a target register assigned to a segment described by the segment descriptor is identified within the target segment table.

Once the target register is identified, at process block 438, a target ISA predicate register assigned to the identified target register is updated to identify the target register containing a base address of the segment register. In other words, in one embodiment, target ISA predicate registers are used by the translated application to provide a mapping between logical addresses contained within the translated application and the target register containing a base address of the segment associated with the logical address. In one embodiment, the mapping between predicate and target registers is illustrated in FIGS. 3 and 4.

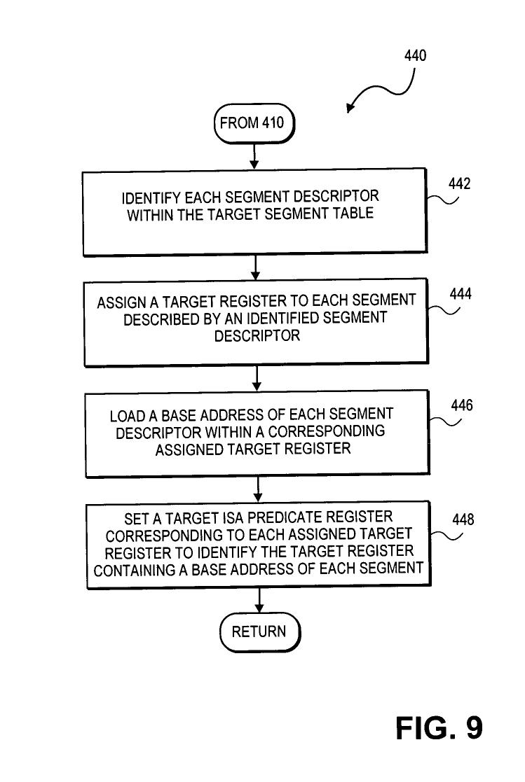

FIG. 9 is a flowchart illustrating a method 440 for, for example, processing one of a segment table update instruction and a segment register update instruction within a source ISA application. At process block 432, each segment descriptor within the target segment table is identified. Once identified, at process block 444, a target register is assigned to each segment described by an identified segment descriptor. At process block 446, a base address of each segment descriptor is loaded within the target register assigned to the segment corresponding to the segment descriptor.

Once each base address is loaded, at process block 448, a target ISA predicate register assigned to the corresponding target register loaded with a base address of the corresponding segment is identified. Accordingly, a translated application can identify the target register containing a base address of each segment utilized by a current application thread. In one embodiment, method 440 is repeated each time the translator encounters a segment table update instruction or a segment register update instruction within a source ISA application.

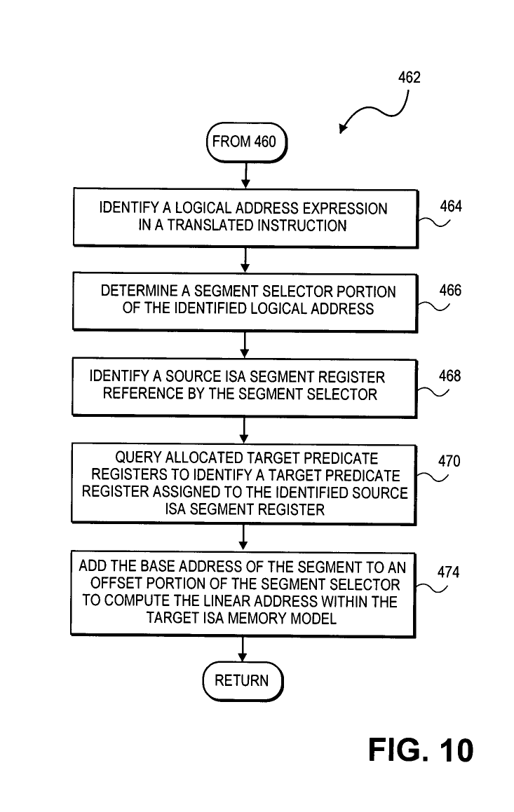

FIG. 10 is a flowchart illustrating a method 462 for simulating the segmented addressing model within the target ISA in accordance with one embodiment of the invention. At process block 464, it is determined whether a logical address instruction is detected within a translated instruction. Once detected, at process block 466, a segment selector portion of the identified logical address is determined. Once determined, at process block 468, a source ISA segment register is identified with reference to the segment selector. At process block 470, allocated target predicate registers are queried to identify a target predicate register assigned to the identified source ISA segment register. In one embodiment, process block 470 is performed utilizing pseudo-code, illustrated in Table 1.

TABLE 1

IF (flag[seg_rl] == USE_SEG1) THEN

linear_address = seg_base_reg1 + offset;

ENDIF
IF (flag[seg_r1] == USE_SEG2) THEN

linear_address = seg_base_reg2 + offset;

ENDIF

.
.
.

IF (flag[seg_r1] == USE_SEGN) THEN

linear_address = seg_base_regN + offset;

ENDIF

In an alternative embodiment, the mapping between source segment registers and allocated target ISA registers containing a base address of the corresponding segment may be performed utilizing a target ISA data structure or the like to provide the desired mapping. However, as will be recognized by those skilled in the art, predicate registers provide high speed translation between source ISA logical addresses and target ISA linear addresses, as described above. At process block 472, a target register containing a base address of the segment is identified by the identified target predicate register. Once identified, at process block 474, the base address of the segment is added to an offset portion of the logical address to compute a linear address within the target ISA memory model.

In one embodiment, method 462 is performed, as illustrated with reference to FIG. 4, as described above. Accordingly, one embodiment of the invention introduces an optimized approach for a dynamic binary translator to simulate a segmented addressing model and a target architecture that is limited to a flat memory addressing model. In the embodiments described, a target ISA segment table, as well as registers of the target architecture and state mapping information, such as predicate registers, are utilized to contain the values to enable conversion of a segmented addressing logical address into a target ISA linear address. Accordingly, translated code to convert logical addresses to linear addresses by checking corresponding flags to identify a target register containing a base address to enable run time linear address calculation.

Alternate Embodiments

Several aspects of one implementation of the translator for providing simulation of a segment addressing model have been described. However, various implementations of the translator provide numerous features including, complementing, supplementing, and/or replacing the features described above. Features can be implemented in software or as part of the processor or chipset in different embodiment implementations. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

In addition, although an embodiment described herein is directed to a binary translator, it will be appreciated by those skilled in the art that the embodiments of the present invention can be applied to other systems. In fact, systems for implementing simulation of a memory subdivision methodology for an architecture fall within the embodiments of the present invention, as defined by the appended claims. The embodiments described above were chosen and described in order to best explain the principles of the embodiments of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

1. A method comprising:
translating instructions from a source instruction set architecture (ISA) having a segmented memory addressing model into a target ISA having a non-segmented memory addressing model;
executing the translated instructions; and
simulating, during execution of the translated instruction, a segmented addressing model within the target ISA for the translated instructions.

2. The method of claim 1, wherein translating instructions comprises:
detecting a segment table update; and
updating a segment table maintained by the target ISA according to the detected segment table update.

3. The method of claim 2, wherein detecting the segment table update comprises:
identifying a segment descriptor associated with the segment table update;
determining a segment base address according to the identified segment descriptor; and
storing the segment base address within a target ISA register assigned to a segment described by the identified segment descriptor.

4. The method of claim 2, wherein updating the segment table comprises:
identifying a segment descriptor associated with the segment table update;
inserting the identified segment descriptor within the segment table maintained by the target ISA; and
updating the segment table maintained by the target ISA to identify a target ISA register assigned to a segment described by the identified segment descriptor.

5. The method of claim 1, wherein prior to translating the instructions, the method comprises:
allocating a target ISA segment table to enable a segmented memory addressing model within the target ISA;
designating one or more target ISA registers as segment base registers to contain segment base addresses of segments utilized by a source application; and
allocating a target ISA predicate register for each of the one or more allocated target registers.

6. The method of claim 1, wherein translating comprises:
detecting a segment register update instruction; and
updating a source ISA state according to the segment register update instruction.

7. The method of claim 1, wherein updating the source ISA state comprises:
querying the target ISA segment table according to a segment selector of the detected segment register update instruction;
identifying a target register assigned to a segment described by the segment descriptor within the target segment table; and
setting a target ISA predicate register assigned to the identified target register to identify the target register containing a base address of the segment.

8. The method of claim 1, wherein translating comprises:
identifying each segment descriptor within the target segment table;
assigning a target register to each segment described by an identified segment descriptor;
loading a base address of each segment descriptor within the target register assigned to the segment; and
setting a target ISA predicate register assigned to each identified target register to identify the target register containing a base address of each segment used by a source application thread.

9. The method of claim 1, wherein simulating the segmented addressing model comprises:
identifying a logical address expression in a translated instruction; and
calculating a linear address for the identified logical address according to a target register containing a base address of a segment identified by the logical address.

10. The method of claim 9, wherein calculating the linear address comprises:
determining a segment selector portion of the identified logical address;
identifying a source ISA segment register reference by the segment selector;
querying allocated target predicate registers to identify a target predicate register assigned to the identified source ISA segment register;
detecting a target register containing a base address of the segment identified by the segment selector according to the identified target predicate register; and
adding the base address of the segment to an offset portion of the logical address to compute the linear address within the target ISA memory model.

11. An article of manufacture including a machine readable medium having stored thereon instructions which may be used to program a system to perform a method, comprising:
translating instructions from a source instruction set architecture (ISA) having a segmented memory addressing model into a target ISA having a non-segmented memory addressing model;
executing the translated instructions; and
simulating, during execution of the translated instruction, a segmented addressing model within the target ISA for the translated instructions.

12. The article of manufacture of claim 11, wherein translating instructions comprises:
detecting a segment table update; and
updating a segment table maintained by the target ISA according to the detected segment table update instruction.

13. The article of manufacture of claim 12, wherein detecting the segment table update comprises:
identifying a segment descriptor associated with the segment table update;
determining a segment base address according to the identified segment descriptor; and
storing the segment base address within a target ISA register assigned to a segment described by the identified segment descriptor.

14. The article of manufacture of claim 12, wherein updating the segment table comprises:
identifying a segment descriptor associated with the segment table update;
inserting the identified segment descriptor within the segment table maintained by the target ISA; and
updating the segment table maintained by the target ISA to identify a target ISA register assigned to a segment described by the identified segment descriptor.

15. The article of manufacture of claim 11, wherein translating the instructions the method comprises:
allocating a target ISA segment table to enable a segmented memory addressing model within the target ISA;
designating one or more target ISA registers as segment base registers to contain segment base addresses of segments utilized by a source application; and
allocating a target ISA predicate register for each of the one or more allocated target registers.

16. The article of manufacture of claim 11, wherein translating comprises:
detecting a segment register update instruction; and
updating a source ISA state according to the segment register update instruction.

17. The article of manufacture of claim 11, wherein updating the source ISA state comprises:
querying the target ISA segment table according to a segment selector of the detected segment register update instruction;
identifying a target register assigned to a segment described by the segment descriptor within the target segment table; and
setting a target ISA predicate register assigned to the identified target register to identify the target register containing a base address of the segment.

18. The article of manufacture of claim 11, wherein translating comprises:
identifying each segment descriptor within the target segment table;
assigning a target register to each segment described by an identified segment descriptor loading a base address of each segment descriptor within the target register assigned to the segment; and
setting a target ISA predicate register assigned to each identified target register to identify the target register containing a base address of each segment used by a source application thread.

19. The article of manufacture of claim 11, wherein simulating the segmented addressing model comprises:
identifying a logical address expression in a translated instruction; and
calculating a linear address for the identified logical address according to a target register containing a base address of a segment identified by the logical address.

20. The article of manufacture of claim 11, wherein calculating the linear address comprises:
determining a segment selector portion of the identified logical address;
identifying a source ISA segment register reference by the segment selector;
querying allocated target predicate registers to identify a target predicate register assigned to the identified source ISA segment register;
detecting a target register containing a base address of the segment identified by the segment selector according to the identified target predicate register; and
adding the base address of the segment to an offset portion of the logical address to compute the linear address within the target ISA memory model.

21. An apparatus, comprising:
a processor; and
a memory coupled to the processor, the memory including a translator to translate instructions from a source instruction set architecture (ISA) having a segmented memory addressing model into a target ISA having a non-segmented memory addressing model, to execute the translated instructions and to simulate, during execution of the translated instruction, a segmented addressing model within the target ISA for the translated instructions.

22. The apparatus of claim 21, wherein the translator is to identify a segment descriptor associated with a detected segment table update, to determine a segment base address according to the identified segment descriptor, and to store the segment base address within a target ISA register assigned to a segment described by the identified segment descriptor.

23. The apparatus of claim 21, wherein the translator is to identify a segment descriptor associated with a detected segment table update, to insert the identified segment descriptor within a segment table maintained by the target ISA, and to update the segment table to identify a target ISA register assigned to a segment described by the identified segment descriptor.

24. The apparatus of claim 21, wherein the translator is to query a segment table maintained by the target ISA according to a segment selector of a detected segment register update, to identify a target register assigned to a segment described by the segment descriptor within the segment table, and to set a target ISA predicate register assigned to the identified target register to identify the target register containing a base address of the segment.

25. The apparatus of claim 21, wherein the translator is to identify each segment descriptor within a segment table maintained by the target ISA, to assign a target register to each segment described by an identified segment descriptor, to load a base address of each segment descriptor within the target register assigned to the segment, and to set a target ISA predicate register assigned to the identified target register to identify the target register containing a base address of the segment.

26. A system comprising:
a chipset;
a double data rate (DDR) synchronous dynamic random access memory (SDRAM) (DDR-SDRAM) memory coupled to the chipset, the memory including a translator to translate instructions from a source instruction set architecture (ISA) having a segmented memory addressing model into a target ISA having a non-segmented memory addressing model, to execute the translated instructions and to simulate, during execution of the translated instruction, a segmented addressing model within the target ISA for the translated instructions.

27. The system of claim 26, wherein the chipset further comprises:
a memory controller coupled to the memory,

28. The system of claim 27, wherein the chipset further comprises:
an input/output (I/O) controller coupled to the memory controller.

29. The system of claim 27, wherein the chipset further comprises:
a graphics controller coupled to the memory controller.

30. The system of claim 27, further comprising:
a processor coupled to the chipset via a front side bus.
